(19) United States
(12) Patent Application Publication
(10) Pub. No.: US 2018/0052537 A1
(43) Pub. Date: Feb. 22, 2018

(54) THREE-DIMENSIONAL IMAGE DISPLAY GLASSES FOR SMART DEVICE HAVING TOUCH FUNCTION

(71) Applicant: Suk Tae GONG, Anseong-si (KR)

(72) Inventor: Suk Tae GONG, Anseong-si (KR)

(21) Appl. No.: 15/555,178

(22) PCT Filed: Mar. 3, 2016
(86) PCT No.: PCT/KR2016/002164

§ 371 Date: Sep. 1, 2017

(30) Foreign Application Priority Data
Mar. 5, 2015 (KR) 10-2015-0031290
May 26, 2015 (KR) 10-2015-0073143

(51) Int. Cl. G06F 3/0354; G06F 3/0362; G06F 3/041

(52) U.S. Cl. CPC G06F 3/03548; H04N 13/0429; G06F 3/041; G06F 3/0362

(57) ABSTRACT

The present invention provides three-dimensional image display glasses that comprise: a smart device positioning part on which a smart device is placed; a smart device fixing and mounting part that fixes the smart device placed on the smart device positioning part; a face contact part having a box shape that is open at the front thereof and configured such that the screen of the smart device is fixed to the open front thereof by the smart device positioning part and the smart device fixing and mounting part, the face contact part comprising two lenses that are disposed to enable the screen of the smart device, which is fixed to the front of the face contact part, to be viewed from the back side that faces the front of the face contact part; and a main body that includes at least one touch button, one side of which makes contact with the fixed screen of the smart device and an opposite side of which protrudes outward from the box shape, wherein the touch button varies the electric field in a position where the touch button is brought into contact with the screen of the smart device by a viewer's operation.

### TECHNICAL FIELD

The present invention relates to three-dimensional image display glasses for a smart device, and more particularly, to three-dimensional image display glasses for a smart device which have a touch function to indirectly touch and drag across a screen of a smart device by manipulating a touch button provided at an outer portion of the three-dimensional image display glasses, instead of directly touching the screen of the smart device installed in the three-dimensional image display glasses.

### BACKGROUND ART

As interest in three-dimensional stereoscopic images and virtual reality has recently increased, a variety of devices, which enable a user to experience three-dimensional stereoscopic images and virtual reality through smart devices, have been developed.

In particular, three-dimensional image display glasses for a smart device that allow a smart device to be installed thereon and display a three-dimensional image through synthesis of left and right split images for 3D display to be displayed in a smart device have been developed and are commercially available.

However, these three-dimensional image display glasses are widely applied to applications for promotion of model houses and for gaining experience such as fire suppression experience. Accordingly, such three-dimensional image display glasses are provided to a variety of users for promotion and experience, are difficult to return, and are distributed to maximize promotion and experience. Thus, customers, who want to provide promotion and experience through three-dimensional image display glasses, require three-dimensional image display glasses with low manufacturing costs.

FIG. 1 is a perspective view illustrating a structure of general three-dimensional image display glasses for a smart device, which are used for distribution. The structure of the general three-dimensional image display glasses for a smart device will be described with reference to FIG. 1. The general three-dimensional image display glasses for a smart device include a main body 10, a smart device fixing and mounting part 20, and a smart device positioning part 30. The main body 10 has a box shape with an opening at a front surface thereof, and includes a face contact part 13 having an oval shape that enables a user to position eyes thereof against a rear surface corresponding to the front surface and including lenses 40-1 and 40-2 to provide a 3D image through synthesis of images for 3D display, displayed on a screen of a smart device 100 placed in front of the glasses, to be viewed by a user. In addition, the main body 10 includes Velcro tapes 12-1 and 12-2 at a main body top part 11.

The smart device 100 is positioned on the smart device positioning part 30 so that a screen thereof faces the front surface of the main body 10.

The smart device fixing and mounting part 20 is configured such that, to fix the smart device 100 positioned on the smart device positioning part 30, a front cover part 22 covers a rear surface (a surface opposite the screen) of the smart device 100 and a top cover part 21 extending perpendicular to the front cover part 22 is attached to a front portion of the main body top part 11, thereby being coupled to the main body 10. Velcro tapes 21-1 and 21-2 provided at opposite sides of the top cover part 21 of the smart device fixing and mounting part 20 are adhered to the Velcro tapes 12-1 and 12-2 of the main body top part 11 of the main body 10 so that the smart device fixing and mounting part 20 is attached to the main body top part 11. The smart device 100 should be configured such that images for 3D display are being displayed before the smart device 100 is positioned on the smart device positioning part 30 or before the top cover part 21 of the smart device fixing and mounting part 20 is attached to the main body top part 11 of the main body 10.

When the images for 3D display are being displayed on the smart device 100, the smart device 100 is installed via the smart device fixing and mounting part 20, and then a viewer positions a face thereof against the face contact part 13 such that eyes of the viewer can be placed on the two lenses 40-1 and 40-2 of the face contact part 13, the viewer may view, as a three-dimensional image, the images for 3D display being displayed on the smart device 100 via the two lenses.

As described above, conventional three-dimensional image display glasses are produced for distribution. Thus, conventional three-dimensional image display glasses are used only for watching a simple 3D video, and thus a screen of a smart device cannot be touched, and, accordingly, it is impossible to control the functions of a smart device. Since the functions of a smart device cannot be controlled, as described above, images for 3D display have to be displayed before positioning the smart device 100 on the smart device positioning part 30, resulting in user inconvenience.

In addition, in conventional three-dimensional image display glasses, to control the function of a smart device while a 3D image is displayed, a screen of the smart device 100 is clicked after the smart device fixing and mounting part 20 is detached from the top cover part 21, and then the smart device fixing and mounting part 20 is attached to the top cover part 21, or the screen of the smart device 100 should be touched with a finger via a gap between the glasses, resulting in high inconvenience.

To address these problems, three-dimensional image display glasses for a smart device in which a separate device is installed on a smart device to control functions of the smart device have been developed and are commercially available, but manufacturing costs are high and it is thus difficult to use such glasses for distribution.

### DISCLOSURE

### Technical Problem

Therefore, the present invention has been made in view of the above problems, and it is one object of the present invention to provide three-dimensional image display glasses for a smart device which have a touch function that enables indirect touching and dragging of a screen of a smart device by manipulating a touch button provided on an external portion of the three-dimensional image display glasses, instead of directly touching the screen of the smart device installed on the three-dimensional image display glasses, and may be produced at low cost to be used for distribution.

### Technical Solution

In accordance with one aspect of the present invention, provided is three-dimensional image display glasses for a smart device which have a touch function, the three-dimensional image display glasses including: a smart device positioning part allowing a smart device to be positioned thereon; a smart device fixing and mounting part to fix the smart device positioned on the smart device positioning part; and a main body having a box shape with an opening at a front surface thereof, a screen of the smart device being fixed to the front surface by the smart device positioning part and the smart device fixing and mounting part, and including: a face contact part including a pair of lenses via which the screen of the smart device fixed to the front surface is viewed at a rear surface facing the front surface; and one or more touch buttons, one side of which contacts the screen of the fixed smart device and another side of which protrudes outside of the box shape to change an electric field at a position thereof contacting the screen of the smart device by manipulation of a viewer. The touch button is provided at a front surface of a main body top part, the smart device positioning part is configured such that one side thereof extends from a lower end of the front surface of the main body and connected thereto in an integrated form, and the smart device fixing and mounting part is configured in a “ [symbol] ” shape, one side thereof being connected to another side of the smart device positioning part in an integrated form and another side thereof being detachable from the main body top part, and is provided, at a portion of the other side thereof, with a groove not to cover the touch button.

The touch button is provided at a front surface of a main body top part, the smart device positioning part is configured such that one side thereof extends from a lower end of the front surface of the main body and connected thereto in an integrated form, and the smart device fixing and mounting part comprises: a front cover part covering a rear surface of the smart device and the front surface of the main body, one side of the front cover part being connected to another side of the smart device positioning part in an integrated form; and a top cover part connected to another side of the front cover part in a “ [symbol] ” shape, another side of the top cover part being detachable from the main body top part, wherein the top cover part covers the main body top part and includes a touch button insertion hole at a position corresponding to the touch button so as for the touch button to be exposed to the outside.

The touch button includes: a first bar fixed to a lower surface of the main body top part and extending from the lower surface in a direction inside the main body, perpendicular to the front surface of the main body; a second bar provided in a lower end direction from the front surface of the main body and connected to the first bar in a “ [symbol] ” shape; a touch electrode provided on an top portion of an end of the first bar and protruding outside of the main body top part; and a screen touch part provided on a top portion of an end of the second bar and protruding to be brought into contact with the screen of the smart device. The touch button is configured such that the second bar is hinge-coupled to the first bar so as to move towards the front of the main body, and further comprises an elastic member provided at a lower surface of the first bar and a rear surface of the second bar on which the screen touch part is installed, to push the second bar towards the front of the main body and generating force pushing the second bar forward.

The touch button includes: a rotary shaft arranged in parallel to the screen of the smart device, having a large length, and performing a rotation operation; a drag/touch part having one side connected in perpendicular to the rotary shaft and another side dragging across the screen of the fixed smart device by rotation of the rotary shaft; and a jog dial connected to the rotary shaft and protruding outside of the main body to rotate according to manipulation of a viewer to thereby rotate the rotary shaft.

The touch button is provided at a main body top part of the main body to drag across the screen of the smart device from left to right or from right to left.

The touch button is provided at one or more of a left side surface portion and a right side surface portion of the main body to drag across the screen of the smart device from up to down or from down to up.

### Advantageous Effects

According to the present invention, three-dimensional image display glasses include a touch button, one side of which contacts a screen of a smart device and another side of which is positioned on an external portion of the three-dimensional image display glasses so that a user can touch the touch button, and thus an effect of touching the screen of the smart device can be obtained by simply touching the touch button positioned on the external portion of the three-dimensional image display glasses.

In addition, the three-dimensional image display glasses include a jog dial touch button, and thus a drag touch function can be realized simply by manipulation of the jog dial touch button without directly dragging across the screen of the smart device with a finger, and thus a wider variety of functions can be controlled.

Accordingly, the present invention has an effect of controlling various functions of the smart device without directly touching the screen of the smart device with a finger of a user.

In addition, according to the present invention, various functions of the smart device can be controlled using the touch button positioned on an external portion of the three-dimensional image display glasses, and thus the touch button can be configured to include an electrode, a jog dial, and the like, whereby increase in manufacturing costs can be minimized.

In addition, according to the present invention, the three-dimensional image display glasses can be produced at minimized manufacturing costs and thus can be used for distribution.

### DESCRIPTION OF DRAWINGS

FIG. 1 is a view illustrating a structure of general three-dimensional image display glasses for a smart device.

FIG. 2 is a view illustrating a structure of three-dimensional image display glasses for a smart device which have a touch function according to a first embodiment of the present invention.

FIG. 3 is a view illustrating a structure of three-dimensional image display glasses for a smart device which have a touch function according to a second embodiment of the present invention.

FIG. 4 is a side view of the three-dimensional image display glasses for a smart device which have a touch function according to the first and second embodiments of the present invention.

FIG. 5 is a side view of three-dimensional image display glasses for a smart device which have a touch function according to a third embodiment of the present invention.

FIG. 6 illustrates a first example of a touch button structure of the three-dimensional image display glasses for a smart device which have a touch function according to the prevention.

FIG. 7 illustrates a second example of a touch button structure of the three-dimensional image display glasses for a smart device which have a touch function according to the prevention.

FIG. 8 illustrates a third example of a touch button structure of the three-dimensional image display glasses for a smart device which have a touch function according to the prevention.

FIG. 9 illustrates a fourth example of a touch button structure of the three-dimensional image display glasses for a smart device which have a touch function according to the prevention.

### DESCRIPTION OF MAIN ELEMENTS OF THE DRAWINGS

1: three-dimensional image display glasses
11: main body top part
12: Velcro tapes
13: face contact part
14: nose insertion part
15: left side surface portion
16: right side surface portion
21: top cover part
22: front cover part
23: Velcro tapes
100: smart device
110: touch button insertion part
111: button main body
112: button hook shaft
113: touch electrode
114: screen touch part
115: hinge
116: elastic member
120: touch button
130: jog dial touch button
131: rotary shaft
132: jog dial
133: drag touch part
200: main body
300: smart device fixing and mounting part
310: touch button insertion hole
400: smart device positioning part

### BEST MODE

Three-dimensional image display glasses for a smart device according to the present invention include: a smart device positioning part on which a smart device is positioned; a smart device fixing and mounting part to fix the smart device positioned on the smart device positioning part; and a main body having a box shape with an opening at a front surface thereof, a screen of the smart device being fixed to the front surface by the smart device positioning part and the smart device fixing and mounting part, and including: a face contact part including a pair of lenses via which the screen of the smart device fixed to the front surface is viewed at a rear surface facing the front surface; and one or more touch buttons, one side of which contacts the screen of the fixed smart device and another side of which protrudes outside of the box shape to change an electric field at a position thereof contacting the screen of the smart device by manipulation of a viewer.

### MODE

Hereinafter, the structure and operation of the three-dimensional image display glasses for a smart device which have a touch function according to the present invention will be described with reference to the accompanying drawings.

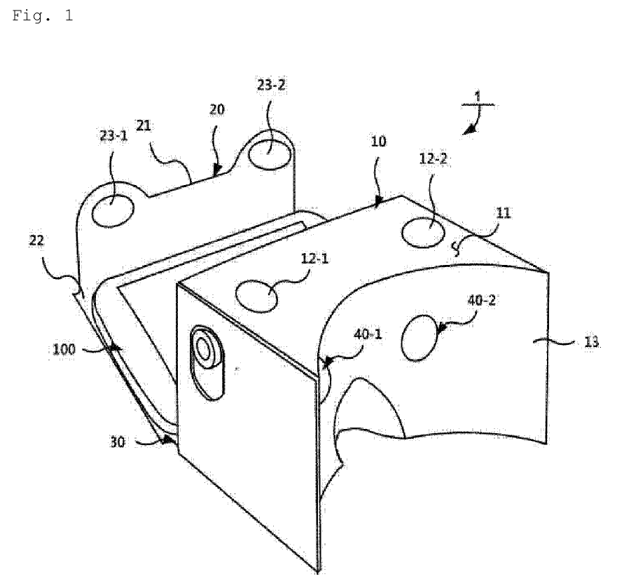

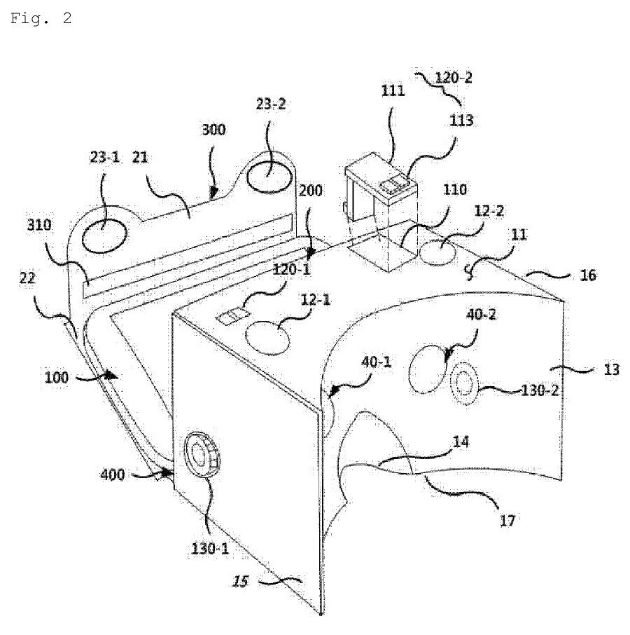

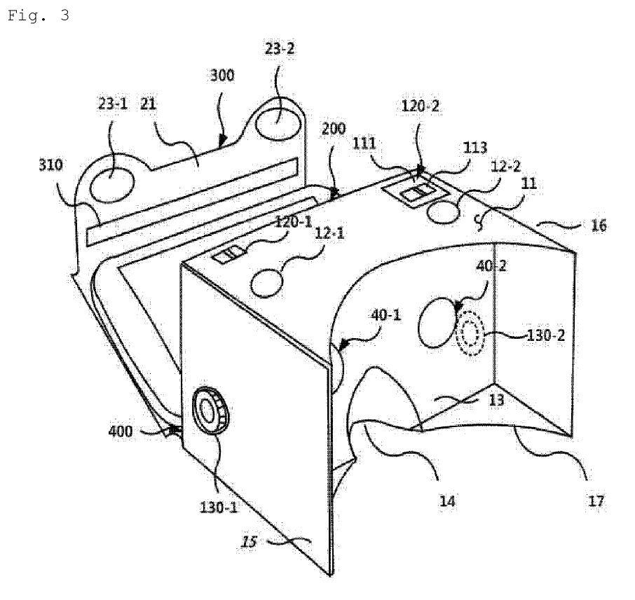

FIG. 2 is a view illustrating a structure of three-dimensional image display glasses for a smart device which have a touch function according to a first embodiment of the present invention. FIG. 3 is a view illustrating a structure of three-dimensional image display glasses for a smart device which have a touch function according to a second embodiment of the present invention. In FIGS. 2 and 3, the same elements as those of FIG. 1 denote the same reference numerals. Hereinafter, the structure and operation of the three-dimensional image display glasses according to the first and second embodiments will be described with reference to FIGS. 2 and 3.

Three-dimensional image display glasses 1 for a smart device which have a touch function according to the present invention include a main body 200, a smart device fixing and mounting part 300, and a smart device positioning part 400. The main body 200 includes a main body top part 11, a face contact part 13, a left side surface portion 15, a right side surface portion 16, and a bottom surface portion 17, and has a box shape with an opening at a front surface thereof.

As illustrated in FIGS. 2 and 3, rear ends of the main body top part 11 and the bottom surface portion 17 are portions into which a face of a viewer is inserted and have a curved shape.

The face contact part 13 may have a curved shape as in the first embodiment of FIG. 2, or have a rectangular shape as in the second embodiment of FIG. 3.

The face contact part 13 includes a nose insertion part 14 via which a nose is inserted, and a pair of lenses 40-1 and 40-2 inserted into portions corresponding to positions of eyes of a human to provide a 3D image through synthesis of images for 3D display being displayed on a screen of a smart device 100 positioned on the front surface of the main body to be viewed by a viewer.

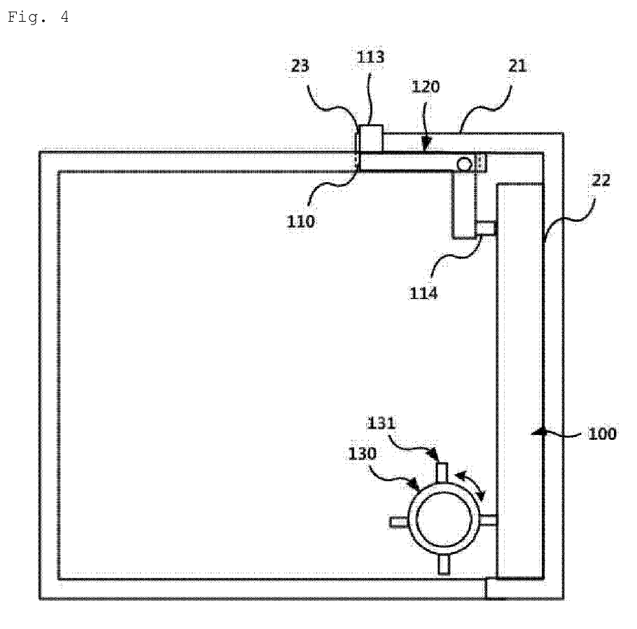

The main body top part 11 includes one or more touch button insertion portions 110 positioned in the front thereof, a touch button 120 inserted into the one or more touch button insertion portions 110, and a Velcro tape 12. The size of the touch button insertion portions 110 may vary according to a method of fixing the touch button insertion portions 110. For example, as illustrated in FIGS. 2 and 3, when a touch button 120-1 is inserted into a lower surface of the main body top part 11 of the main body 10, it is required that only a touch electrode 113, which will be described below, of the touch button 120-1 protrude outside, and thus the size of the touch button insertion portions 110 does not need to be large. In contrast, as illustrated in FIG. 4, when a touch button 120-2, which will be described below, is hook-coupled to the inside of the touch button insertion portion 110 by a button hook shaft 112, the size of the touch button insertion portion 110 has to be increased as in FIGS. 2 and 3.

As illustrated in FIGS. 2 and 3, the Velcro tape 12 may include two Velcro tapes on left and right sides or may also include a single Velcro tape at the center.

In addition, the touch button 120 may be provided in singular or plural at an arbitrary position in the front of the main body top part 11.

The touch button 120 is configured such that an end of one side of the touch button 120 contacts the screen of the smart device 100 positioned on the smart device positioning part 400 and closely contacting an opening at the front surface of the main body 10 by the smart device fixing and mounting part 300, and, as illustrated in FIGS. 2 and 3, an end of another side of the touch button 120 protrudes outside of the main body top part 11 and provides an effect as if, when a viewer touches the touch button 120 with a finger, the contact portion of the end of one side thereof is touched by static electricity of a human body.

Although FIGS. 2 and 3 illustrate that the touch button 120 is provided on the left or right side of the main body top part 11, the touch button 120 may also be positioned at the center or may be positioned only at the center according to the number of touch buttons.

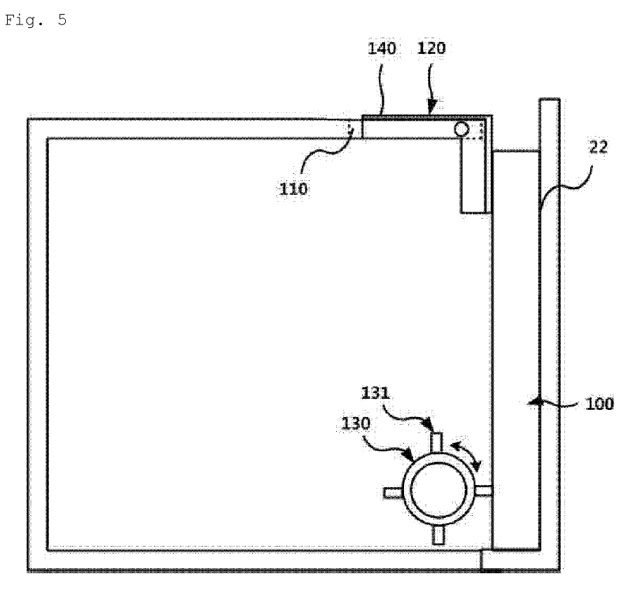

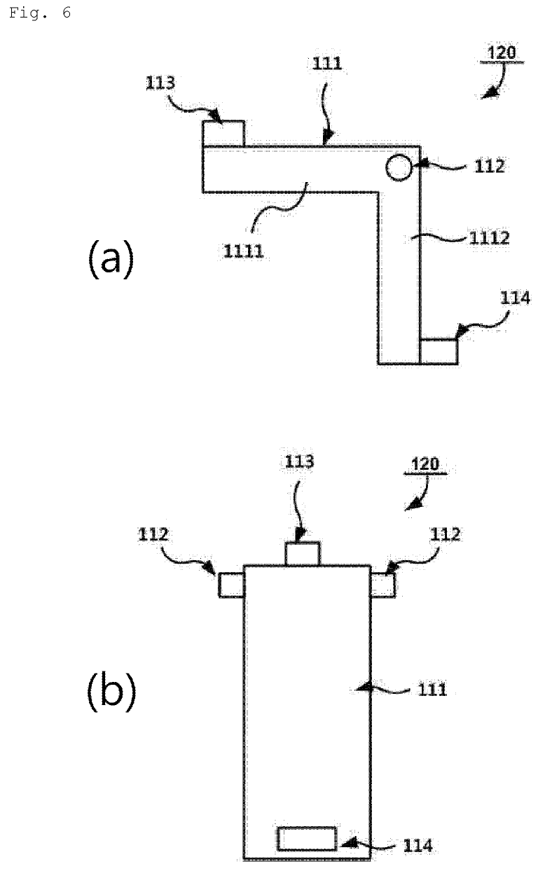

The touch button 120 may also be configured on the left side surface portion 15 and the right side surface portion 16. Detailed structure and operation of the touch button 120 will now be described in detail with reference to FIGS. 5 and 6.

However, touch buttons disposed on the left and right side surface portions 15 and 16 may be configured in a jog dial form including jog dial touch buttons 130-1 and 130-2 that provide an effect of dragging across a screen. The jog dial touch buttons 130-1 and 130-2 configured on the left and right side surface portions 15 and 16 provide an effect of dragging (touching) from up to down, or from down to up.

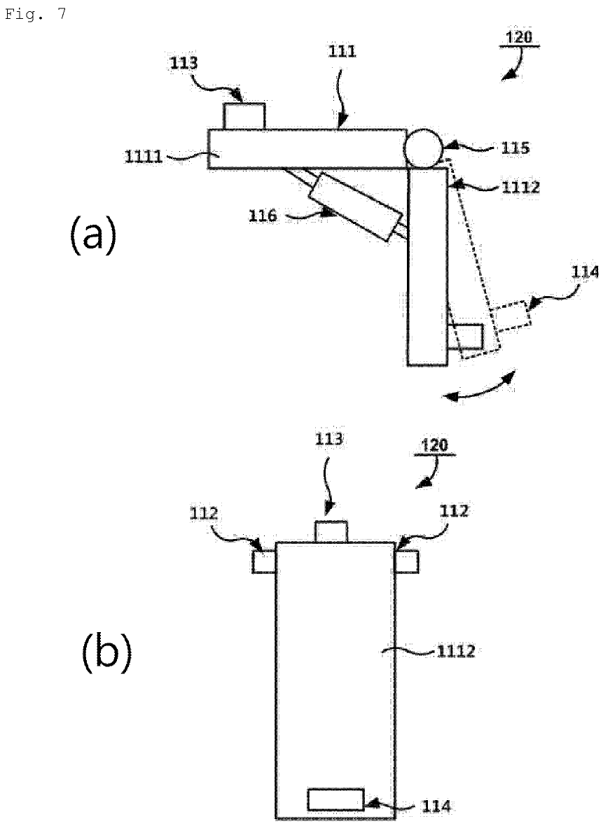

A jog dial touch button 130 may also be configured at the main body top part 11, thereby providing an effect of dragging from left to right, or from right to left. Structure and operation of the jog dial touch button 130 will now be described in detail with reference to FIG. 7. The smart device positioning part 400, on which the smart device 100 is positioned, extends from an edge of a lower end of the front surface of the main body 10 to correspond to the thickness of the smart device 100.

The smart device fixing and mounting part 300 is configured in an integrated form perpendicular to the smart device positioning part 400 and includes the front cover part 22 to cover a rear surface of the smart device 100, i.e., a battery cover part, and cover the front surface of the main body 10 and the top cover part 21 connected perpendicular to the front cover part 22 to cover a front portion of the main body top part 11 of the main body 10 and configured to be detached from the main body top part 11.

The top cover part 21 may be provided, at a portion in which the touch button 120 is positioned, with a touch button insertion hole 310, a touch button groove, or the like, through which the touch button 120 protruding outside of the main body top part 11 is exposed to the outside. Although not shown in the drawings, the touch button groove may have an uneven shape at an end portion of the top cover part 21.

In addition, the top cover part 21 may include a Velcro tape as a detachable means, and, as illustrated in FIGS. 2 and 3, the Velcro tape may be disposed at a position that does not affect the touch button insertion hole 310.

In the foregoing description, a case in which the top cover part 21 is configured to cover the front portion of the top part of the main body 10 has been described. However, the top cover part 21 may be connected to an end portion of the front surface of the main body 10 in an integrated form, or may not be configured as illustrated in FIG. 4, which will be described below. In the former, an opening may be formed in one or more sides of opposite side surfaces of the smart device positioning part 400 so that the smart device 100 can be inserted therethrough to be positioned on the smart device positioning part 400. In the latter, an opening may be formed in a top portion of the smart device positioning part 400 so that the smart device 100 can be inserted therethrough and removed therefrom.

Although a case in which the smart device fixing and mounting part 300 is configured to cover the rear surface of the smart device 100 and the front portion of the main body top part 11 of the main body 10 has been described with reference to FIGS. 2 and 3, the smart device fixing and mounting part 300 may be configured as a holder to hold the smart device 100 in a state in which the smart device 10 positioned on the smart device positioning part 400 is placed on the front surface of the main body 10, or the smart device fixing and mounting part 300 and the main body 10 may be configured in an integrated form, or the smart device 100 may be configured to be inserted into the smart device positioning part 400.

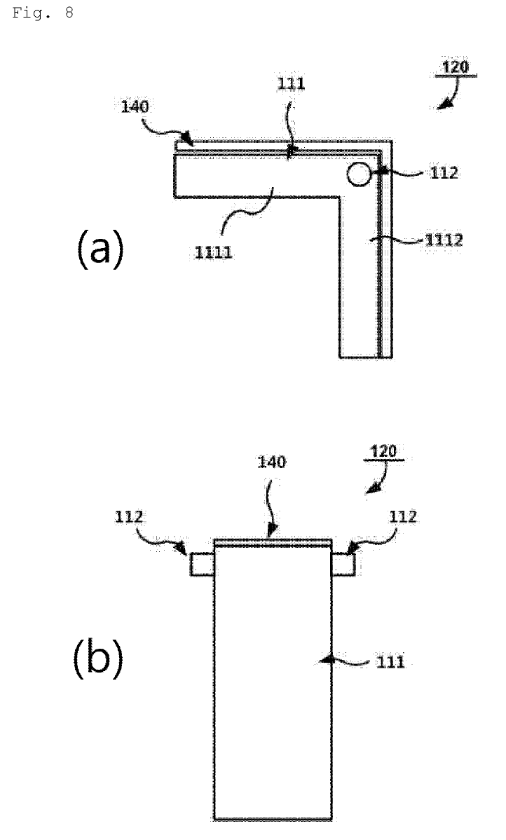

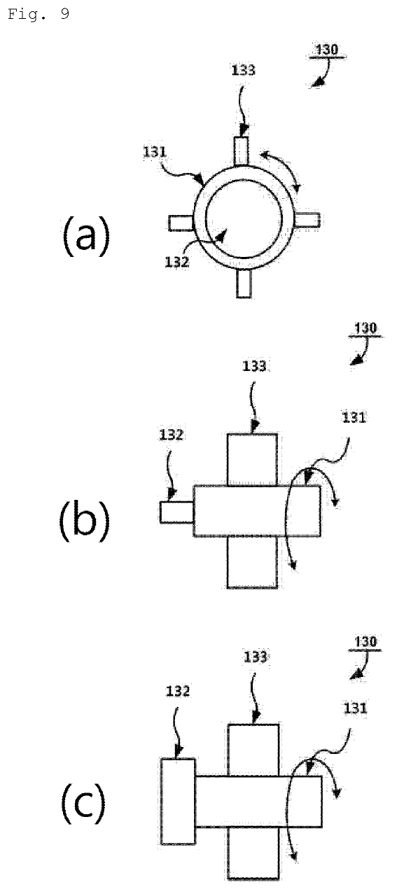

FIG. 4 is a side view of the three-dimensional image display glasses for a smart device which have a touch function according to the first and second embodiments of the present invention. FIG. 5 is a side view of three-dimensional image display glasses for a smart device which have a touch function according to a third embodiment of the present invention. FIG. 6 illustrates a first example of a touch button structure of the three-dimensional image display glasses for a smart device which have a touch function according to the prevention. FIG. 7 illustrates a second example of a touch button structure of the three-dimensional image display glasses for a smart device which have a touch function according to the prevention. FIG. 8 illustrates a third example of a touch button structure of the three-dimensional image display glasses for a smart device which have a touch function according to the prevention. FIG. 9 illustrates a fourth example of a touch button structure of the three-dimensional image display glasses for a smart device which have a touch function according to the prevention. Hereinafter, the above embodiments will be described with reference to FIGS. 4 to 9. The main body 10 according to the present invention may be made of paper, plastic, or the like having a constant thickness.

As described above, as illustrated in FIG. 4, the touch button 120 may be configured at the main body top part 11, and the jog dial touch button 130 may be disposed at one or more of the left and right side surface portions 15 and 16.

First, structure and operation of the touch button 120 will be described with reference to FIG. 6. As illustrated in FIGS. 4 and 6, the touch button 120 includes a “ [symbol] ”-shaped button main body 111, the touch electrode 113 protruding outside of the main body top part 11 so that a viewer can touch the touch electrode 113 with a finger, and a screen touch part 114 brought into contact with the screen of the smart device 100 fixed by the smart device fixing and mounting part 300, and further includes the button hook shafts 112 protruding from opposite sides of the “ [symbol] ”-shaped bent portion of the button main body 111 according to embodiment. The button main body 111 includes a first bar 1111 coupled in parallel to the main body top part 11 and a second bar 1112 coupled at 90 degrees or more with respect to the first bar 1111. According to the first example, as illustrated in FIG. 6, the touch button 120 may include the first and second bars 1111 and 1112 configured in an integrated form. The button main body 111 may be made of a conductor and a semiconductor that allows static electricity formed in the human body to be transmitted to the screen (touch pad) of the smart device 100, or a conductor or a semiconductor that connects the touch electrode 113 to the screen touch part 114 may be configured through the inside of the button main body 111. However, for simplicity, the button main body 111 may be made of any one of a conductor and a semiconductor. The screen touch part 114 may be made of a silicon or the like similarly to a general stylus, or may be made of aluminum or the like.

As illustrated in FIGS. 2 and 4, the touch button 120 may be inserted into the touch button insertion part 110 of the main body top part 11 and fixed, or may be attached to a lower surface of the inside of the main body top part 11 and fixed.

In a case in which the touch button 120 is inserted into the touch button insertion part 110, the button hook shafts 112 are hook-coupled to opposite sides of the inside of the touch button insertion part 110 and thus inserted into the touch button insertion part 110. When the touch electrode 113 of the touch button 120 coupled in such a manner is touched by a viewer, the button main body 111 rotates about the button hook shaft 112 as an axis in a direction in which touch force is transmitted, and thus the screen touch part 114 may more strongly contact the screen of the smart device 100.

In addition, the touch button 120 may be attached and fixed to the lower surface of the main body top part 11. In this case, as shown in the insertion structure of the touch button 120-1 of FIGS. 2 and 3, the touch button insertion part 110 may be formed only to a size corresponding to the touch electrode 113.

The touch button 120 according to the second example may include the first and second bars 1111 and 1112 configured in a separate form not in an integrated form such that the first and second bars 1111 and 1112 are hinge-coupled by a hinge 115, and further include an elastic member 116 at a lower surface of the first bar 1111 and a rear surface of the second bar 1112, on which the screen touch part 114 is configured. Since the first bar 1111 is fixed to the main body top part 11, the elastic member 116 pushes the second bar 1112 in a direction in which the smart device 100 is positioned, and, accordingly, the screen touch part 114 may strongly contact the screen of the smart device 100. Since the screen touch part 114 strongly contacts the screen of the smart device 100, touch performance may be enhanced. The first bar 1111, the hinge 115, and the second bar 1112 may also be made of any one of a conductor and a semiconductor that allows static electricity of the human body to be transmitted to the screen of the smart device 100, or separate conductor and semiconductor that connect the touch electrode 113 to the screen touch part 114 may be connected through the inside of the touch button 120.

In addition, as illustrated in FIG. 4, in a case in which an opening is formed in a top portion of the smart device positioning part 400, when the smart device 100 is inserted into the smart device positioning part 400, the touch button 120 has to be configured such that the screen touch part 114 can be touched. In this case, the touch button 120 may be configured as illustrated in FIG. 8. The touch button 120 of FIG. 8 may include the button main body 111 and an electrode part 140 adhered along an outer side of the button main body 111. The electrode part 140 may be made of aluminum or the like. The electrode part 140 may have the same width as that of the button main body 111, or may have a smaller width than that of the button main body 111.

In such configuration illustrated in FIG. 8, as illustrated in FIG. 4, the touch button 120 may be configured in the touch button insertion part 110 of the main body top part 11 such that the electrode part 140 attached to the second bar 1111 of the button main body 111 protrudes farther than an end portion of the front surface of the main body top part 11 of the main body 200. In this case, the touch button insertion part 110 may have an opening at a front surface thereof.

In a case in which the smart device 100 is inserted into the smart device positioning part 400, the structure of the jog dial touch button 130 according to the fourth example will now be described with reference to FIG. 9. The jog dial touch button 130 includes a rotary shaft 131 arranged in parallel to the screen of the smart device 100, a drag/touch part 133 coupled in perpendicular to the rotary shaft 131 and configured to touch and drag the screen of the smart device 100, and a jog dial 132 connected to one end of the rotary shaft 131 and protruding from the left and right side surface portions 15 and 16 of the main body 200 as illustrated in FIGS. 2 and 3 to be rotatable by a viewer. When the viewer rotates the jog dial 132, the drag/touch part 133 touches the screen of the smart device 100 while moving from up to down, or from down to up according to the direction of rotation, whereby an effect of dragging from up to down or from down to up may be provided. The rotary shaft 131, the jog dial 132, and the drag/touch part 133 may be made of any one of a conductor and a semiconductor that allows static electricity of the human body to reach the screen of the smart device 100. The drag/touch part 133 may be formed of general silicon to prevent the screen of the smart device 100 from being scratched.

Meanwhile, it will be easily understood by those of ordinary skill in the art that the present invention is not limited to the aforementioned typical exemplary embodiments and various modifications, changes, substitutions, or additions may be made without departing from the essence of the present invention. These modifications, changes, substitutions, or additions should be construed as being within the spirit of the present invention as long as they are within the scope of the appended following claims.

### INDUSTRIAL APPLICABILITY

Three-dimensional image display glasses for a smart device which have a touch function include a touch button having one side brought into contact with a screen of a smart device and another side formed on an external portion of the three-dimensional image display glasses to be touched by a user, and thus an effect of touching the screen of the smart device may be obtained by simply touching a touch switch configured on an external portion of the three-dimensional image display glasses. In addition, the three-dimensional image display glasses include a jog dial touch button, and thus a drag/touch function may be used only by manipulation of a jog dial touch button without directly dragging across the screen of the smart device with a finger and, accordingly, an effect of controlling various functions may be obtained. Thus, the present invention is very useful and also highly industrially applicable.

1. Three-dimensional image display glasses for a smart device which have a touch function, the three-dimensional image display glasses comprising: a smart device positioning part allowing a smart device to be positioned thereon; a smart device fixing and mounting part to fix the smart device positioned on the smart device positioning part; and a main body having a box shape with an opening at a front surface thereof, a screen of the smart device being fixed to the front surface by the smart device positioning part and the smart device fixing and mounting part, and comprising: a face contact part comprising a pair of lenses via which the screen of the smart device fixed to the front surface is viewed at a rear surface facing the front surface; and one or more touch buttons, one side of which contacts the screen of the fixed smart device and another side of which protrudes outside of the box shape to change an electric field at a position thereof contacting the screen of the smart device by manipulation of a viewer.

2. The three-dimensional image display glasses according to claim 1, wherein the touch button is provided at a front surface of a main body top part, the smart device positioning part is configured such that one side thereof extends from a lower end of the front surface of the main body and connected thereto in an integrated form, and the smart device fixing and mounting part is configured in a “ [symbol] ” shape, one side thereof being connected to another side of the smart device positioning part in an integrated form and another side thereof being detachable from the main body top part, and is provided, at a portion of the other side thereof, with a groove not to cover the touch button.

3. The three-dimensional image display glasses according to claim 1, wherein the touch button is provided at a front surface of a main body top part, the smart device positioning part is configured such that one side thereof extends from a lower end of the front surface of the main body and connected thereto in an integrated form, and the smart device fixing and mounting part comprises: a front cover part covering a rear surface of the smart device and the front surface of the main body, one side of the front cover part being connected to another side of the smart device positioning part in an integrated form; and a top cover part connected to another side of the front cover part in a “ [symbol] ” shape, another side of the top cover part being detachable from the main body top part, wherein the top cover part covers the main body top part and comprises a touch button insertion hole at a position corresponding to the touch button so as for the touch button to be exposed to the outside.

4. The three-dimensional image display glasses according to claim 1, wherein the touch button is provided at a front surface of a main body top part, the smart device positioning part is configured such that one side thereof extends from a lower end of the front surface of the main body and connected thereto in an integrated form and at least one side from among opposite side surfaces and an upper portion has an opening, and the smart device fixing and mounting part comprises a front cover part having one side connected to another side of the smart device positioning part in an integrated form and configured so as to cover a rear surface of the smart device inserted.

5. The three-dimensional image display glasses according to any one of claims 1 to 4, wherein the touch button comprises: a first bar fixed to a lower surface of the main body top part and extending from the lower surface in a direction inside the main body, perpendicular to the front surface of the main body; a second bar provided in a lower end direction from the front surface of the main body and connected to the first bar in a “ [symbol] ” shape; a touch electrode provided on an top portion of an end of the first bar and protruding outside of the main body top part; and a screen touch part provided on a top portion of an end of the second bar and protruding to be brought into contact with the screen of the smart device.

6. The three-dimensional image display glasses according to claim 5, wherein the touch button is configured such that the second bar is hinge-coupled to the first bar so as to move towards the front of the main body, and further comprises an elastic member provided at a lower surface of the first bar and a rear surface of the second bar on which the screen touch part is installed, to push the second bar towards the front of the main body and generating force pushing the second bar forward.

7. The three-dimensional image display glasses according to claim 1, wherein the touch button comprises: a rotary shaft arranged in parallel to the screen of the smart device, having a large length, and performing a rotation operation; a drag/touch part having one side connected in perpendicular to the rotary shaft and another side dragging across the screen of the fixed smart device by rotation of the rotary shaft; and a jog dial connected to the rotary shaft and protruding outside of the main body to rotate according to manipulation of a viewer to thereby rotate the rotary shaft.

8. The three-dimensional image display glasses according to claim 7, wherein the touch button is provided at a main body top part of the main body to drag across the screen of the smart device from left to right or from right to left.

9. The three-dimensional image display glasses according to claim 7, wherein the touch button is provided at one or more of a left side surface portion and a right side surface portion of the main body to drag across the screen of the smart device from up to down or from down to up.
